(19) United States
(12) Patent Application Publication
(10) Pub. No.: US 2024/0303462 A1
(43) Pub. Date: Sep. 12, 2024

(54) MULTI-PLATFORM NEURAL NETWORK DEPLOYMENT

(71) Applicant: ADOBE INC., San Jose, CA (US)

(72) Inventors: Zichuan LIU, San Jose, CA (US); Xin LU, Saratoga, CA (US); Wentian ZHAO, San Jose, CA (US)

(21) Appl. No.: 18/119,488

(22) Filed: Mar. 9, 2023

(51) Int. Cl. G06N 3/04

(52) U.S. Cl. CPC G06N 3/04

(57) ABSTRACT

In various examples, a machine learning model is converted for execution by a computing device. For example, a computing graph is generated based on the machine learning model and sub-graphs within the computing graph that match sub-structures that are detected and combined into a vertex to generate an optimized computing graph. A net-list object and weight object are then generated based on the optimized computing graph and provided to the computing device to enable inferencing operations.

### BACKGROUND

Various types of artificial intelligence (AI) models such as Deep Neural Networks (DNNs) have become widespread tools to solve a wide variety of real-world problems, such as image editing, self-driven system, and video processing. In addition, these DNNs can be executed using various platforms such as using a cloud-based Neural Network application or executed by a Neural Network (NN) model on a local device without additional data transmission. In addition, local devices (e.g., mobile devices) generally use fewer computation resources than other devices such as laptops, desktops, and servers computer systems. As a result, in various examples, NN models trained by existing machine learning frameworks are unable to be directly executed on local devices and must be converted to enable execution on local devices such as mobile devices.

### SUMMARY

Embodiments described herein are directed to converting AI models, such as NN models, for execution within a specific environment. For example, a NN model is converted and optimized for execution by mobile devices with specific architecture and/or software libraries. Advantageously, in various embodiments, the systems and methods described are directed towards a conversion tool that can recognize and optimize various NN model structures and/or sub-structures automatically and allow layer mapping to a kernel library. In particular, the conversion tool generates a device specific net-list object and weight object to allow the device kernel to perform inferencing on the device. For example, the net-list object describes the connectivity between layers in the NN model and the weight object indicates the weights values of the NN model.

In various examples, the conversion tool includes a model parser, graph optimizer, a graph tracer and a net-list generator. In such examples, the model parser translates the NN model to a computing graph with directed edges indicating a computing order and data dependencies with the vertices of the computing graph representing operators (e.g., convolution, batch normalization, inverted concatenation, etc.). Furthermore, operators supported by the conversion tool, in an example, are defined in an operator library. In addition, graph optimizer of the conversion tool, for example, simplifies the computing graph structure by combining vertices and edges according to the sub-structures defined in a macro library. In this example, the macro library defines isometric sub-structures that correspond to a software kernel that can process all of the vertices of the sub-structure (e.g., in a single operation or execution of the software kernel).

In particular, the graph optimizer can detect the sub-structures (e.g., defined in the macro library) using a sub-graph isomorphism algorithm to match sub-graphs of the computing graph to the sub-structures. Furthermore, the resulting optimized graph, in an example, is compared to the computing graph (e.g., the original computing graph representing the NN model generated model parser) to verify output consistency and extract the run-time parameters (e.g., the parameters of the NN model). The net-list generator, in this example, then generates a device specific net-list object and weight object based on the optimized graph and run-time parameters.

The systems and methods described are capable of converting NN models for execution by specific devices. In particular, the conversion tool enables a computing device with limited computing resources to perform inferencing locally by combining multiple layers of the NN model (e.g., sub-structures of the computing graph) for execution by a single kernel (e.g., software or other executable code) specific to the computing device. For example, an inference framework of the computing device utilizes the net-list object and weight object to perform inferencing, where the net-list object indicates specific kernel functions to be executed (e.g., connectivity between layers in the NN model) and the weight object indicates parameters to the specific kernel functions.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts an environment in which a conversion tool generates a net-list object and a weight object, in accordance with at least one embodiment.

FIG. 3 depicts an environment in which a conversion tool generates a net-list object and a weight object, in accordance with at least one embodiment.

FIG. 4 depicts an environment in which a conversion tool generates a computing graph, in accordance with at least one embodiment.

FIGS. 5A-5G depict an environment in which a conversion tool generates a set of macros defining isomorphic sub-structures, in accordance with at least one embodiment.

FIG. 6 depicts an environment in which a conversion tool generates an optimized computing graph, in accordance with at least one embodiment.

FIG. 7 depicts an example process flow for generating a net-list object and weight object, in accordance with at least one embodiment.

FIG. 8 is a block diagram of an exemplary computing environment suitable for use in implementations of the present disclosure.

### DETAILED DESCRIPTION

Embodiments described herein generally relate to a model conversion tool that optimizes or otherwise improves performance and efficiency of machine learning models during execution by a computing device (e.g., mobile devices, edge devices, etc.). In accordance with some aspects, the systems and methods described are directed to a conversion tool that generates a computing graph representing the machine learning model, where vertices represent layers of the machine learning model and edges represent data flow between the layers, and then optimizes the computing graph for execution by a computing device based on a software kernel or other executable code of the computing device. Furthermore, in various embodiments, the conversion tool includes macros which define sub-structures (e.g., isometric sub-graphs) that, when detected in the computing device, can be condensed or otherwise simplified into a single vertex. For example, a user can define a macro that indicates a combination of layers of the machine learning model (e.g., a convolution layer, a bath normalization layer, and a rectified linear units layer) that can be combined into a single operation (e.g., single vertex) of the kernel of the computing device.

In various embodiments, the conversion tool generates a net-list object and a weight object that are utilized by an inference framework of the computing device to perform inferencing. For example, the computing device obtains an input (e.g., an image) and performs a set of operations (e.g., kernel operations) defined in the net-list object using parameters (e.g., model weights) defined in the weight object to generate an output (e.g., classification of the image). In an embodiment, in order to generate the net-list object and the weight object, the conversion tool parses the machine learning model to generate a computing graph. As described in greater detail below, vertices of the computing graph define or otherwise indicate layers of the machine learning model and corresponding operations of the kernel and the directed edges of the computing graph represent data flow between layers of the machine learning model.

The conversion tool, in an embodiment, optimizes or otherwise simplifies the computing graph to generate an optimized computing graph. For example, the conversion tool detects a set of sub-graphs within the computing device that can be reduced to a single vertex. In various embodiments, the conversion tool includes a set of macros that define isomorphic sub-structures that can be reduced to a single operation of the kernel. For example, the user can define a macro that indicates a plurality of layers of a machine learning model that are executable by a single operation of a particular kernel for a particular device. Once the conversion tool has detected all the sub-graphs within the computing graph that can be condensed to a single vertex based on the set of macros (e.g., isomorphic sub-structures) and generated the optimized computing graph, in an embodiment, the conversion tool translates the optimized computing graph to the net-list object and the weight object.

Other solutions can degrade the performance and efficiency of machine learning models on various devices. In one example, when performing inferencing using the machine learning model, the kernel obtains input data from off-chip memory, executes computational operations, and writes the results back to the off-chip memory. In such an example, the large number of vertices (e.g., layers of the machine learning model) in the computing graph requires frequent off-chip memory access and low processor utilization resulting in degraded performance and efficiency. Furthermore, various kernels specific to particular devices can include kernel operations that can combine multiple layers of the machine learning model thereby minimizing the number of off-chip memory operation by utilizing on-chip caches and registers. Other solutions are unable to detect these combinable layers and simplify the computing graph representing the machine learning more prior to generating the net-list object and the weight object. Furthermore, these other solutions require the per-model human involvement to optimize the machine learning model by hand labeling sub-structures that can be combined. These manual deployment workflows can take a considerable amount of time and are prone to human error.

Aspects of the technology described herein provide a number of improvements over existing technologies. For instance, the conversion tool described in various embodiments, provides improved performance and efficiency during inferencing on computing devices such as mobile devices and edge devices as a result of improved usage of computing resources. For example, by implementing a plurality of layers of the machine learning model with a single kernel operation, the number of memory access operations (e.g., off-chip memory) to produce the same result is reduced. In various embodiments, the conversion tool provides simplification of computing graphs representing machine learning models based on a specific kernel library.

In addition, the conversion tool provides a mechanism for users to define, using macros, specific layers of the machine learning model that can be performed using a single kernel operation. Furthermore, the conversion tool described in various embodiments, eliminates the need for human labeling of combinable sub-structures thereby reducing the amount of time needed to optimize model performance and facilitating device specific optimizations. To this end, in various embodiments, the conversion tool provides an optimization framework based on sub-graph isomorphism to detect various macros (e.g., sub-structures) within the computing graph representing the machine learning model that can be combined into a single vertex.

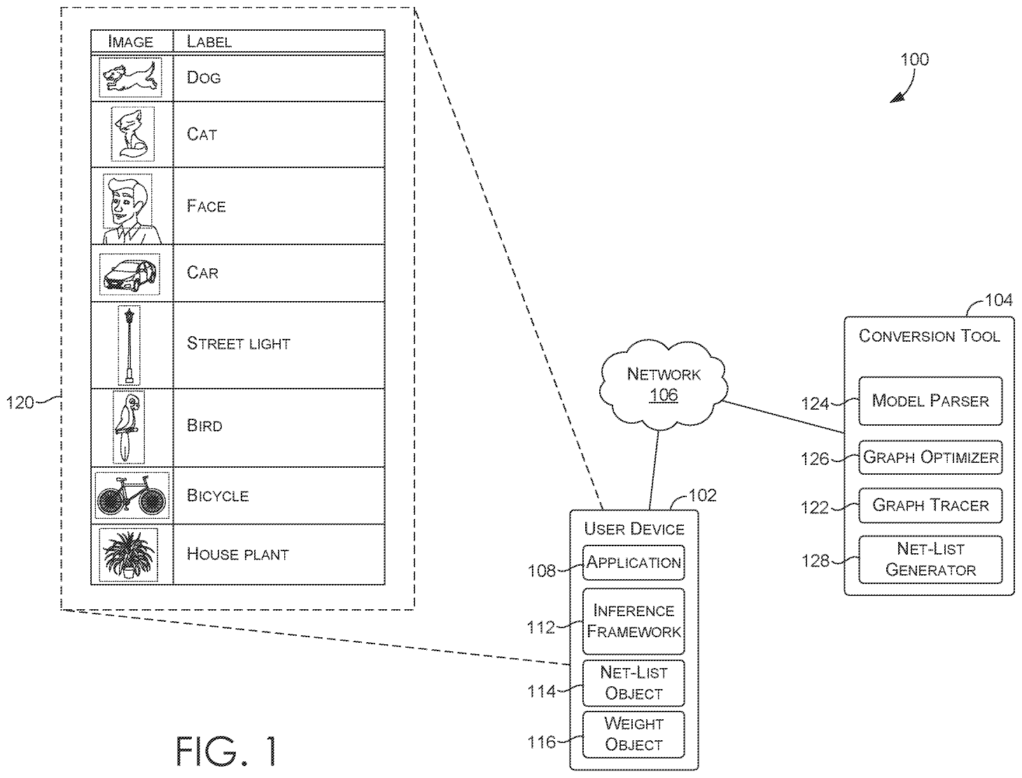

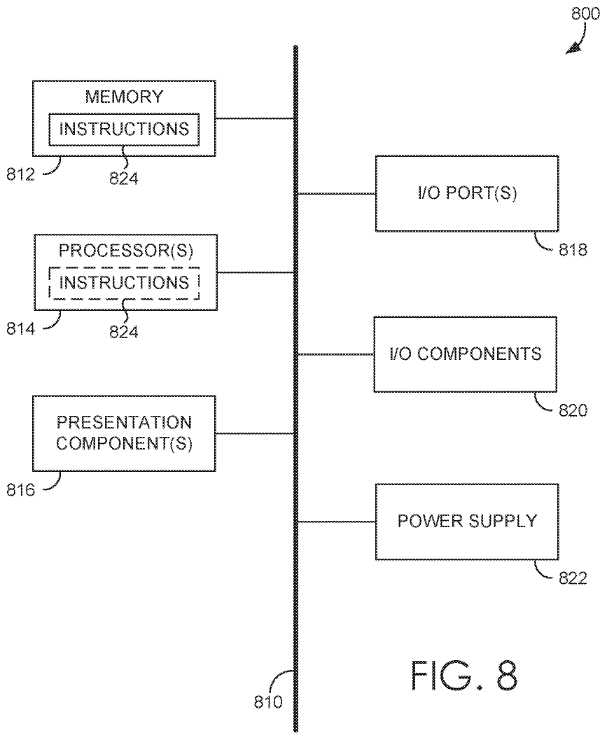

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Furthermore, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 8.

It should be understood that operating environment 100 shown in FIG. 1 is an example of one suitable operating environment. Among other components not shown, operating environment 100 includes a user device 102, a conversion tool 104, and a network 106. Each of the components shown in FIG. 1 can be implemented via any type of computing device, such as one or more computing devices 800 described in connection with FIG. 8, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks.

Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the conversion tool 104 includes multiple computer systems cooperating in a distributed environment to perform the operations described in the present disclosure.

User device 102 can be any type of computing device capable of being operated by an entity (e.g., individual or organization) and obtains data from conversion tool 104 and/or a data store which can be facilitated by the conversion tool 104 (e.g., a server operating as a frontend for the data store). The user device 102, in various embodiments, has access to or otherwise maintains a net-list object 114 and/or weight object 116 used by an inference framework to perform inferencing operations 120 of a machine learning model. For example, the application 108 images as input and causes the inferencing framework 112 to generate labels for the inputs based on the net-list object 114 and the weight object 116. As described in greater detail below the net-list object 114 and the weight object 116, in various embodiments, includes a structured data object or other data defining various aspects (e.g., layers and/or parameters) of the machine learning model implemented by the application 108.

In some implementations, user device 102 is the type of computing device described in connection with FIG. 8. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, an edge device, server computer system, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice. In addition, the user device 102, for example, includes a kernel or other device library that includes computer-readable instructions executable by the one or more processors to perform various computational operations associated with one or more machine learning models (e.g., convolution operations, normalization operations, activation operations, dropout operations, linear operations, nonlinear operations, regression operations, etc.).

In various embodiments, the application 108 includes any application capable of facilitating the exchange of information between the user device 102 and the conversion tool 104. For example, the application 108 can request conversation of a particular machine learning model for execution by the user device 102. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and/or a kernel implemented by the user device 102. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the conversion tool 104. In some embodiments, the components, or portions thereof, of the conversion tool 104 are implemented on the user device 102 or other systems or devices. Thus, it should be appreciated that the conversion tool 104, in some embodiments, is provided via multiple devices arranged in a distributed environment that collectively provides the functionality described herein. Additionally, other components not shown can also be included within the distributed environment.

As illustrated in FIG. 1, the conversion tool includes a model parser 124, a graph optimizer 126, a graph tracer 122, and a net-list generator 128 in accordance with at least one embodiment. In one example, the conversion tool 104 converts a particular machine learning model to the net-list object 114 and the weight object 116 and provides the net-list object 114 and the weight object 116 to the user device 102 to perform various inferencing operations using the inference framework 112. In various embodiments, the model parser 124 of the conversion tool 104 generates a computing graph representing the machine learning model to be converted. In one example, the machine learning model is defined using a format such as the Open Neural Network Exchange (ONNX) format. Furthermore, in an embodiment, the model parser 124 generates the computing graph based on the machine learning model where vertices of the computing graph represent layers of the machine learning model and the edges between the vertices represent data flow between layers (e.g., vertices). In one example, the model parser 124 generates a state-space representation of the computing graph.

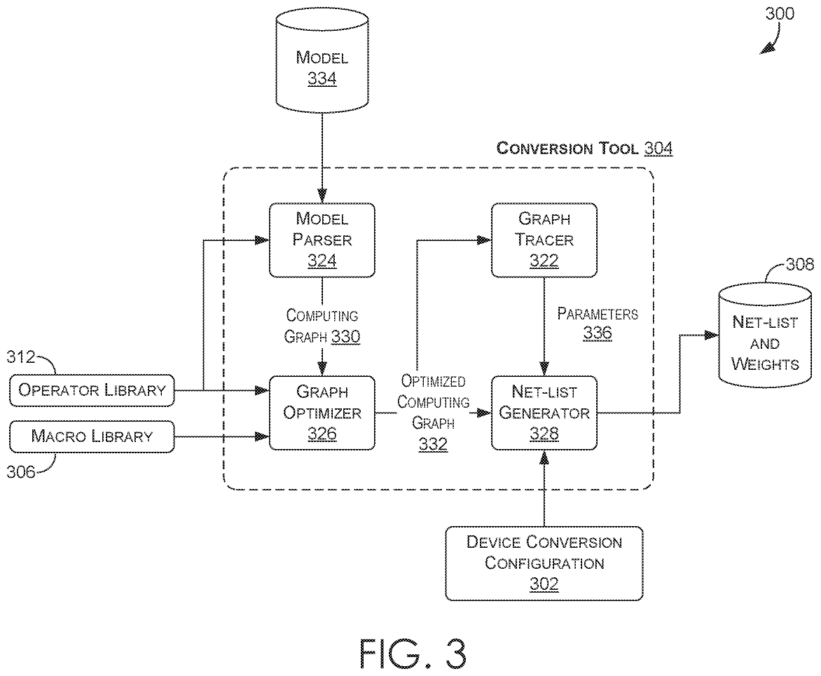

In various embodiments, the graph optimizer 126 of the conversion tool 104 obtains the computing graph from the model parser 124 and generates an optimized computing graph. As described in greater detail below in connection with FIG. 3, the graph optimizer 126, in an embodiment, detects one or more sub-graphs within the computing graph that matches one or more sub-structures. In one example, the sub-structures include isometric sub-graphs (e.g., defined in a macro library) that correspond to kernel operations (e.g., as defined in an operator library).

In various embodiments, a kernel operation combines or otherwise executes a plurality of operations associated with one or more layers of the machine learning model. For example, a particular kernel operation includes a convolution with batch normalization, activation, and residual block. Furthermore, in various embodiments, the sub-structures define a set of vertices and edges that can be performed by a single kernel operation. In one example, the optimized computing graph is generated by detecting sets of vertices (e.g., sub-graphs) that can be replaced with a single vertex and generating the optimized computing graph by at least connecting all input edges of the set of vertices to the single vertex (e.g., from another vertex into the single vertex), removing all edges internal to the set of vertices, and connecting all output edges of the set of vertices to the single vertex (e.g., from the single vertex out to another vertex).

In an embodiment, the graph tracer 122 validates the optimized computing graph to determine that the optimized computing graph and the computing graph generate the same results. For example, the graph tracer 122 determines whether the optimized computing graph generates the same output as the machine learning model. In addition, in an embodiment, the graph tracer 122 extracts or otherwise determines various parameters (e.g., weights) associated with particular vertices (e.g., layers of the machine learning model) of the optimized computing graph. For example, the graph tracer 122 determines weight values to include in the weight object 116.

In various embodiments, the net-list generator 128 generates the net-list object 114 for use by the inference framework 112 of the user device 102. For example, net-list generator 128 obtains the optimized computing graph and the parameters as input and outputs net-list object 114 (e.g., specific to the user device 102) and the weight object 116 based on configuration information defined in a device conversion configuration object. In an embodiment, the device conversion configuration object defines and/or includes executable code that generates records within the net-list object 114 that indicate model weight values and operator types associated with vertices. For example, the net-list generator 128 generates the net-list object 114 based on the configuration information included in the device conversion configuration object and the optimized graph.

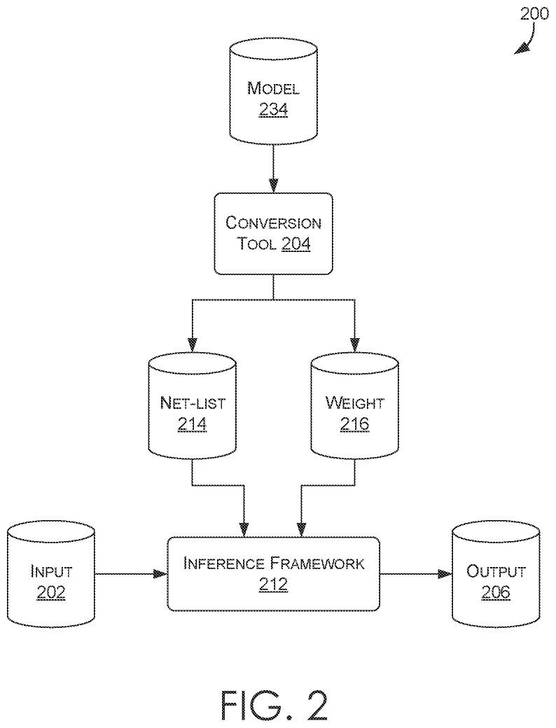

FIG. 2 is a diagram of an environment 200 in which a conversion tool 204 generates a net-list object 214 and a weight object 216 based on a model 234, in accordance with at least one embodiment. In an embodiment, the conversion tool 204 includes various components such as those described above in connection with FIG. 1. For example, the conversion tool 204 includes a model parser, a graph optimizer, a graph tracer, and a net-list generator. Furthermore, in various embodiments, the conversion tool 204 provides the net-list object 214 and the weight object 216 to an inference framework 212 which, when executed by a computing device (e.g., the user device 102 in FIG. 1) takes an input 202 and generates an output 206. For example, the inference framework 212 performs inferencing of the model 234 to generate the output 206 (e.g., label) based on the input 202 (e.g., image).

In various embodiments, the model 234 includes a machine learning model such as a neural network. In other embodiments, the model 234 includes a structured data object (e.g., JavaScript Object Notation (JSON) object) or other data describing the model 234 (e.g., layers and parameters). For example, the model 234 is defined using the ONNX format. In an embodiment, the conversion tool 204 obtains the model 234 as an input and outputs the net-list object 214 and the weight object 216 specific to a particular computing device and/or kernel. In one example, the net-list object 214 describes the connectivity between layers in the model 234 and the weight object 216 describes learned weight values generated by the model 234.

In various embodiments, both the net-list object 214 and the weight object 216 are processed by the inference framework 212 with a kernel implementation to perform inferencing on various computing devices. As described in greater detail below in connection with FIG. 3, sub-structures of the model 234, in various embodiments, are defined and inferencing operations on the various computing devices can be optimized based on sub-graph isomorphism. For example, the model 234 is parsed into a computing graph and during an optimization phase, various sub-structures (e.g., macros) are detected and each detected sub-structure is combined and mapped into a single kernel operation. In various embodiments, the optimized computing graph (e.g., the computing graph generated during the optimization phase) is translated into the net-list object 214 and the weight object 216 based on a corresponding Device Conversion Configuration (DCC).

FIG. 3 is a diagram of an environment 300 in which a conversion tool 304 generates a net-list and weights 308, in accordance with at least one embodiment. In various embodiments, the conversion tool 304 includes a set of routines and/or algorithms to process a model 334 and generate the net-list and weights 308 using an operator library 312, a macro library 306, and DCC 302 information. Furthermore, in an embodiment, the conversion tool 304 also performs consistency verification to ensure that the net-list and weights 308 produce the same result as the model 334 when performing inferencing operations.

In an embodiment, the conversion tool 304 includes of a model parser 324, a graph optimizer 326, a graph tracer 322, and a net-list generator 328. For example, the model parser 324 translates the model 334 (e.g., an ONNX model) into a computing graph 330 with directed edges describing computing order and data dependency and vertices representing operators. In various embodiments, the operators are defined in the operator library 312. For example, the operator library 312 defines a set of kernel operations that can be performed by a user device or similar computing device.

In various embodiments, the computing graph 330 is processed by the graph optimizer 326 to simplify the graph structure by combining vertices and edges according to the sub-structures defined in the macro library 306. For example, the macro library 306 includes a set of sub-structures, where a sub-structure of the set of sub-structures defines a plurality of vertices (e.g., operators and/or layers) that can be performed by a single operator defined in the operator library 312. In various embodiments, the graph optimizer 326 searches the computing graph 330 and detects sub-graphs that are equivalent (e.g., isomorphic) to the sub-structures defined in the macro library 306. In one example, detected sub-graphs are reduces to a single vertex representing a single operator in the operator library 312.

In various embodiments, the resulting optimized computing graph 332 is provided to the graph tracer 322 and compared with the original computing graph 330 to verify the output consistency. In addition, in an embodiment, the graph tracer 322 extracts parameters 336 during the process of verifying output consistency of the optimized computing graph. Furthermore, in some embodiments, these parameters 336 are then used by the net-list generator 328 to generate the net-list and weights 308. For example, the net-list generator 328 obtains the optimized computing graph 332 and the parameters 336 as input and outputs device-specific net-list and weights 308 based on the DCC 302 information.

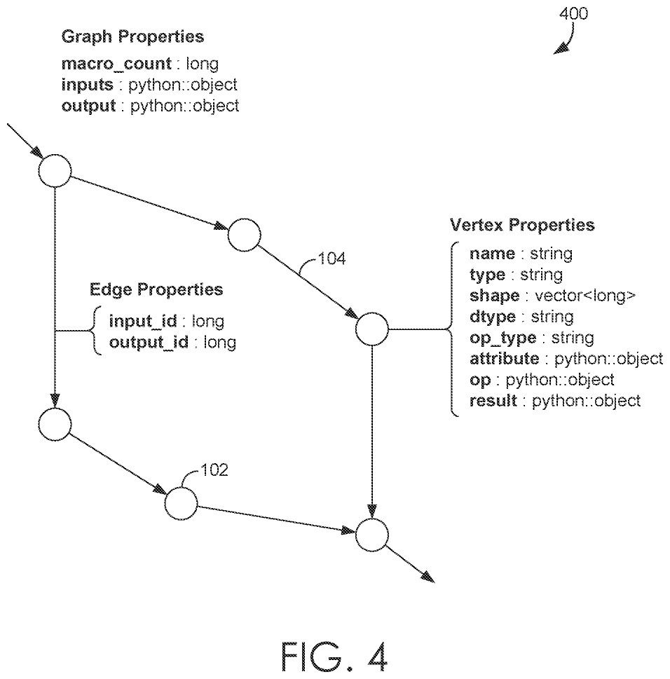

In an embodiment, the model parser 324 obtains the model 334, where the model is defined by a set of operators and data flow (e.g., connectivity) between operators of the set of operators. For example, the model parser 324 generates a directed graph based on the model 334 as illustrated in FIGS. 4-6. In various embodiments, layers of the model 334 are represented as vertices in the computing graph 330 and correspond to operators defined in the operator library 312 (e.g., a kernel in a low-level device library). In one example, the operator library 312 and macro library 306 are defined by a user of the conversion tool 304.

As described above, in various embodiments, the graph optimizer 326 takes the computing graph 330 as an input and generates the optimized computing graph 332. In an example, the layers of the model 334 are represented as vertices in the computing graph 330 and correspond to a kernel in the low-level device library. Furthermore, in such an example, the kernel obtains input data from an off-chip memory of the computing device, performs computations associated with the layer/vertex, and writes the results back to the off-chip memory. In an embodiment, the graph optimizer 326 reduces the number of vertices (e.g., layers) in the computing graph 330 to reduce frequent off-chip memory access and increase processor utilization. For example, a set of layers are defined as a sub-structure within the macro library 306 (e.g., convolution with batch normalization and activation and residual block) are implemented as a single kernel (e.g., defined in the operator library 312) to minimize the off-chip memory access by utilizing on-chip caches and registers.

In various embodiments, the graph optimizer 326 performs a matching processing between a macro Gᵢ and target model G which is described by means of state space representation, where state s of the matching process can be associated to a partial mapping solution M(s), which contains only a subset of M, where M(s) identifies two sub-graphs of Gᵢ and G. For example, let Gᵢ(s) and G(s) be the sub-graphs obtained by selecting from Gᵢ and G only the vertices Vᵢ(s), V(s) included in M(s) and the edges Eᵢ(s), E(s) connecting them, a transition from a generic state s to a successor s′ represents the addition to the partial graphs associated to s in the state space representation of a pair of vertices (vᵢ, v) of matched nodes. In an embodiment, for a set of possible states, subset of states are consistent with a morphism type, such that there are no conditions that preclude the possibility of reaching a complete solution. For example, a consistency condition is that the partial graphs Gᵢ(s) and G (s) associated to M(s) are isomorphic. In various embodiments, the matching process performed by the graph optimizer 326 recursively traverses all the state s and verifies the consistency condition according to a set of feasibility rules, where the feasibility rule is described by the feasibility function F (s, vᵢ, v), which is true if an addition to a state s meets all the feasibility conditions. For example, the feasibility function is represented by the logical ‘and’ of syntactic feasibility F_{syn}(s, vᵢ, v) and the semantic feasibility Fₛₑₘ, (s, vᵢ, v):

$$F ( s , {v}_{i} , v ) = {F}_{s y n} ( s , {v}_{i} , v ) ∧ {F}_{s e m} ( s , {v}_{i} , v ) .$$

In this example, the initial state s₀ does not contain any component and thus M(s₀)=Ø, for an intermediate state s, the matching algorithm computes the set P(s) of the vertex pairs. In various embodiments, for each pair p=(vᵢ, v), the feasibility rules are evaluated and tf F(s, vᵢ, v) is true, a successor state s′ is computed by s′=s∪p and the whole process recursively applies to s′. In one example, the syntactic feasibility condition as defined by various feasibility rules (e.g., R_{pred}, R_{succ}, Rᵢₙ, Rₒᵤₜ and R_{new}). Furthermore, in an embodiment, the semantic feasibility Fₛₑₘ, (s, vᵢ, v) is evaluated by comparing the vertex attributes. For example, the Fₛₑₘ, (s, vᵢ, v) is true if vᵢ and v have the same attributes (e.g., type of vertex, data type, operator type, attribute, result, etc.). In an embodiment, once a matching sub-graph is detected the vertices can be combined into a single vertex in the optimized computing graph 332.

The optimized computing graph 332, in an embodiment, is provided to the graph tracer 322 which traces the optimized graph by at least recursively computing the outputs of all dependent vertices based on specific output vertices. Furthermore, in one example, the parameters 336 (e.g., the size of intermediate results) is recorded during the tracing process and provided to the net-list generator 328 for inclusion in the net-list and weights 308. In an embodiment, the net-list generator 328 generates the net-list and weight 308 based on the optimized graph processed by the graph tracer 322. For example, the net-list generator 328 transverses vertices of the optimized graph 332 in a depth-first manner and, for each vertex, generates a line of a record in the net-list and weights 308. The net-list and weights 308, for example, can include a structured data object such as a JSON file or unstructured data object.

In an embodiment, the record in the net-list and weights 308 includes information associated with a particular vertex and corresponding edges (e.g., layer type, vertex name, number inputs, number outputs, input vertex list, output vertex list, etc.). The format for the record and/or net-list and weights 308, in an embodiment, is defined in the DCC 302. For example, the DCC 302 includes a script or other executable code indicating a set of routines and/or operations for generating the record in the net-list and weights 308 based on an operator type in the computing graph. In an embodiment, net-list generator 328 extracts input and output information, specifies layer-kernel mapping (e.g., mapping a vertex to an operator in the operator library 312), and generating kernel attributes. For example, a vertex containing parameterized layers (e.g. convolution and linear layer) the corresponding weights are defined in a binary weight file. Specifically, in an embodiment, for a convolution and batch normalization macro, the parameters of the batch normalization are merged into the weight w and bias b of the convolution layers according to the following equations:

$$\begin{matrix}w = \frac{{w}_{b n}}{\sqrt{v a {r}_{b n} + ϵ}} \cdot {w}_{c o n v} \\ b = \frac{{w}_{b n}}{\sqrt{v a {r}_{b n} + ϵ}} \cdot ( {b}_{c o n v} - {mean}_{b n} ) + {b}_{b n} ,\end{matrix}$$

where w_{conv}, b_{conv}, mean_{bn}, var_{bn}, w_{bn}, and b_{bn} are the weight and bias parameter of the convolution layer, mean, variance, weight and bias of the batch normalization layer and e is a small constant which is can be set to 10⁻³.

In various embodiments, the algorithm implemented by the conversion tool 304 to generate the net-list and weights 308 is defined by the following pseudo-code:

```
Require: G and {G₁ ... G_{N}}
  for Gᵢ ∈ {G₁ ... G_{N}} do
    s₀ :=: {s|M(s) = Ø}
    Mi < MATCH(s₀, Gᵢ, G)
    for m ∈ Mᵢ do
      G ← COMBINE(m, G)
    end for
  end for
  function MATCH(s₀, Gᵢ, G)
    if M(s) covers all the nodes in Gᵢ then
      Append M(s) to Mᵢ.
    else
      Compute the set P(s) of the pairs candidate for inclusion in M(s).
      for p ∈ P(s) do
        if The feasibility rules succeed for the inclusion of p in M(s)
        then
          Compute the state s′ obtained by adding p to M(s).
          MATCH(s′, Gᵢ, G)
        end if
      end for
      Restore the data structures.
    end if
  end function
  function COMBINE(m, G)
  A macro vertex c.
  for {(v₁, v) ∈ m|v₁ ∈ V₁, v ∈ V} do
    Remove v and all edges connect to v.
  end for
  Connect all input terminal to c.
  Connect all output terminal to c.
  return G
```

FIG. 4 is a diagram depicting computing graph 400 generated by a conversion tool, in accordance with at least one embodiment. In various embodiments, the computing graph includes a set of vertices including a vertex 102 and a set of directed edges between vertices including directed edge 104. In one example, the computing graph is generated by a model parser of the conversion tool as described above in connection with FIG. 3. In other examples, the computing graph includes a sub-structure defined in a macro library, where the sub-structure defines a set of vertices and directed edges that can be combined into a single operator defined in an operator library.

In various embodiments, the vertices (e.g., the vertex 102) denote an operator of a machine learning model and the directed edges (e.g., the directed edge 104) represent the computation flows. Furthermore, in an embodiment, the vertices and the directed edges include or are otherwise associated with a set of properties. For example, the set of properties specify the input and the output vertices in the computing graph 400. In an embodiment, the set of properties are defined to maintain the status of the computing graph 400 throughout the conversion process. The set of properties, in an embodiment, includes various attributes such as a name of the vertex 102, a type of the vertex 102 (e.g., data, operator, etc.), shape of data associated with the vertex 102, data type of data associated with the vertex 102, an operator type associated with the vertex 102, parameters associated with the vertex 102, identification information of input edges associated with the vertex 102, identification information of output edges associated with the vertex 102, macro identification information, a set of input edges, a set of output edges, or any other information used to convert a machine learning model or define isometric sub-structures within the computing graph 400.

In an embodiment, the computing graph 400 includes defined macros which indicate potential combinable sub-structures within a machine learning model during a graph optimization process. For example, the conversion tool detects the sub-structures (e.g., computing graph 400) using a sub-graph isomorphism algorithm capable of matching graphs and sub-graphs with multiple attributes. In an embodiment, an original computing graph is created based on a machine learning model, where the original computing graph is represented by G, the conversion tool then obtains a set of macros (e.g., a set of smaller computing graphs defining sub-structures that can be reduce and/or combined into a single vertex) denoted as Gᵢ∈{G₁ . . . G_{N}} and sequentially compares Gᵢ(Vᵢ, Eᵢ) with G(V, E) to discover isomorphic matching Mᵢ, where element m∈Mᵢ denotes a set of pairs (vᵢ, v) with vᵢ∈Vᵢ and v∈V. In various embodiments, once obtaining m, the conversion tool combines the sub-graph consisting of vertices v∈V into a macro vertex with all the external edges reserved.

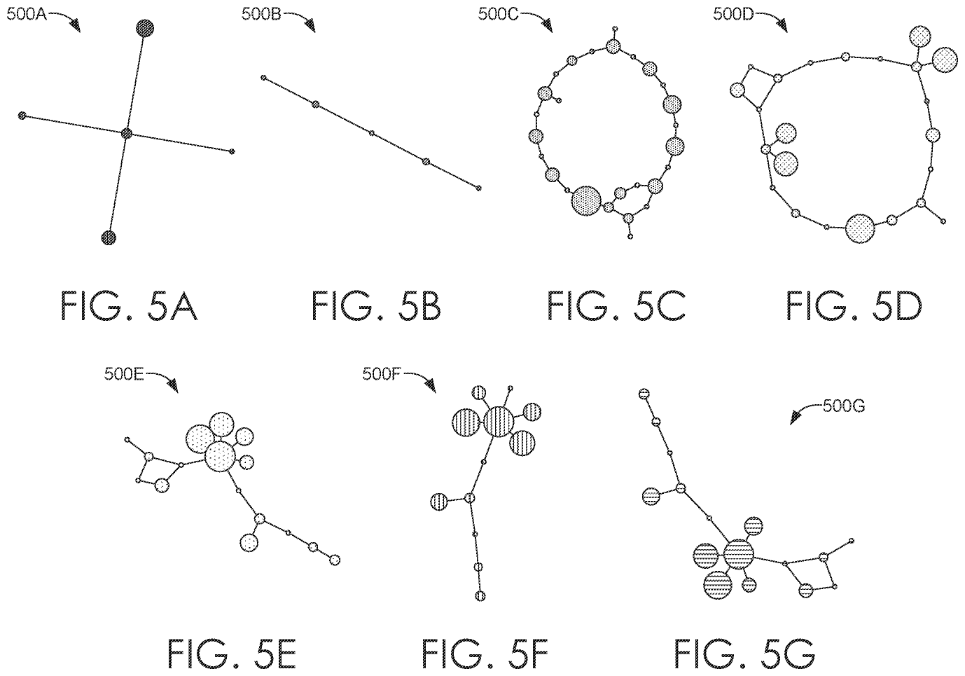

FIGS. 5A-5G depict a set of sub-structures 500A-500G that can be used by a conversion tool to optimize a computing graph in accordance with at least one embodiment. In an embodiment, a user defines the set of sub-structures 500A-500G which are stored in a macro library and used to detect isomorphic sub-graphs within the computing graph. The set of sub-structures 500A-500G include a set of vertices that indicate operators of a machine learning model and a set of directed edges that indicate data flow between operators of the machine learning model.

In one example, the sub-structure 500A represents a depth-wise convolution layer of the machine learning model; the sub-structure 500B represents an inverted concatenation layer of the machine learning model; the sub-structure 500C represents a squeeze-and-excitation (SE) block of the machine learning model; the sub-structure 500D represents an SE and swish layer of the machine learning model; the sub-structure 500E represents a convolution plus padding plus swish layer of the machine learning model; the sub-structure 500F represents a convolution plus padding layer of the machine learning model; and the sub-structure 500G represents a depth-wise convolution plus padding plus swish layer of the machine learning model. The set of sub-structures 500A-500G are illustrated as examples of possible sub-structures that can be combined into a single vertex and other sub-structures can be used in accordance with the various embodiments described to generate macros to be used by the conversion tool during optimization of the computing graph.

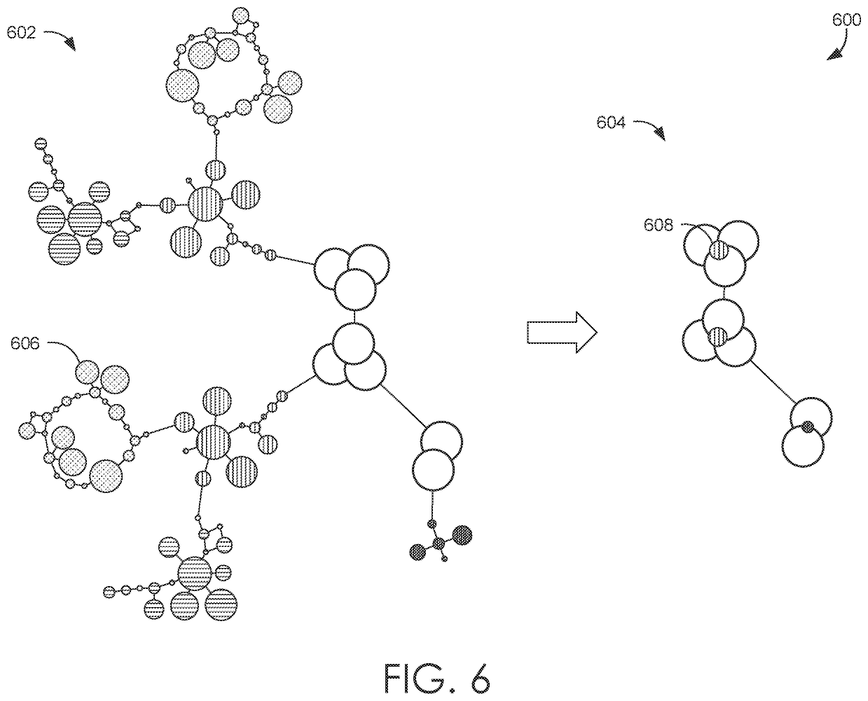

FIG. 6 is a diagram of an environment 600 in which a conversion tool generates an optimized computing graph 604 based on a computing graph 602, in accordance with at least one embodiment. In various embodiments, the conversion tool includes a model parser, such as the model parser 324 described above in connection with FIG. 3, to generate the computing graph 602. For example, the computing graph 602 is generated based on a machine learning model and includes vertices defining layers of the machine learning model and edges between the vertices defining data flow between layers of the machine learning model.

In an embodiment, the conversion tool includes a graph optimizer, such as the graph optimizer 326 described above in connection with FIG. 3, which generates the optimized computing graph 604. In an example, the optimized computing graph 604 is generated by at least detecting a set of sub-graphs within the computing graph 602 (illustrated as shaded circles in FIG. 6) that can be reduced to a single vertex 608 in the optimized computing graph 604. In various embodiments, a sub-graph 606 includes an isomorphic sub-graph of a sub-structure defined in a macro library. For example, the sub-graph 606 includes a plurality of layers of the machine learning model that can be performed by a single kernel operation. In an embodiment, the sub-graphs are detected using any suitable isomorphic graph matching algorithm.

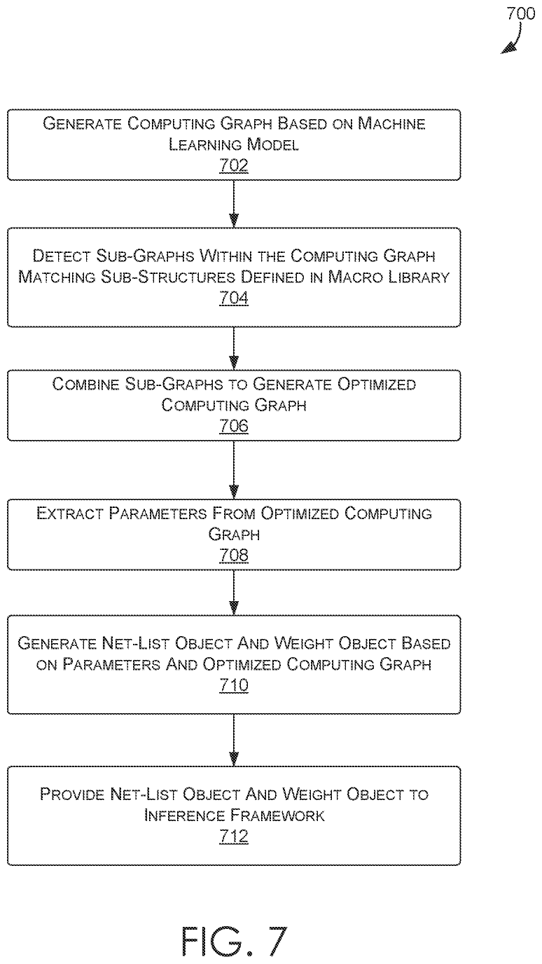

FIG. 7 is a flow diagram showing a method 700 for generating a net-list object and weight object in accordance with at least one embodiment. The method 700 can be performed, for instance, by the conversion tool 104 of FIG. 1 to convert a machine learning model to the net-list object and weight object. Each block of the method 700 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, the system implementing the method 700 generates a computing graph based on a machine learning model. As described above in connection with FIG. 1, in various embodiments, a model parser of the conversion tool generates the computing graph based on the machine learning model (e.g., neural network). For example, the machine learning model is maintained in an ONNX format and the model parser generates the computing graph based on the ONNX format. Furthermore, the computing graph includes a set of vertices representing operators of the machine learning model and a set of edges representing data flow between the operators.

At block 704, the system implementing the method 700 detects sub-graphs within the computing graph that match sub-structures define in a macro library. For example, a macro defines a set of vertices and edges that can be combined into a single vertex corresponding to a kernel operation. As described above, an isomorphic graph matching algorithm, in various embodiments, is used to detect the sub-structures in the computing graph.

At block 706, the system implementing the method 700 combines the sub-graphs to generate the optimized computing graph. In an embodiment, a set of vertices associated with the sub-graph are removed or otherwise replaced with the single vertex, all input edges to the set of vertices are connected to the single vertex, and all output edges from the set of vertices are connected to the single vertex. As described above, in various embodiments, the computing graph includes various properties assigned to the vertices and edges to enable combination of sub-graphs such as vertex names, input information, output information, or any other information suitable for performing the conversion operation described in the present disclosure.

At block 708, the system implementing the method 700 extracts parameters from the optimized computing graph. As described above in connection with FIG. 3, in various embodiments, a graph tracer extracts parameters (e.g., weight values) associated with vertices in the optimized computing graph by at least traversing the optimized computing graph. For example, the graph tracer traces the optimized graph by at least recursively computing the outputs of all dependent vertices based on specific output vertices and extracting the parameters from the vertices as part of the computation operations. In another example, the graph traces traverse the optimized computing graphs and obtains parameters associated with the vertices and/or edges.

At block 710, the system implementing the method 700 generates the net-list object and weight object based on the parameters and the optimized computing graph. In an embodiment, a net-list generator of the conversion tool traverses the optimized computing graph and generates a record for the vertices of the optimized computing graph. In one example, the record indicates operators and parameters indicated in the optimized computing graph. In an embodiment, the net-list generator transverses vertices of the optimized graph in a depth-first manner and, for each vertex, generates a line of the record in the net-list and includes weight values based on the parameters extracted by the graph tracer as described above.

At block 712, the system implementing the method 700 provides the net-list object and the weight object to an inference framework. In an embodiment, a user device, such as the computing device 800 described in greater detail below in connection with FIG. 8, provides an inference framework to perform inferencing based on the machine learning model. For example, the net-list object and weight object indicate to the inference framework a set of kernel operations and parameters in order to perform inferencing based on the machine learning model.

Having described embodiments of the present invention, FIG. 8 provides an example of a computing device in which embodiments of the present invention may be employed. Computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 8 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. As depicted, memory 812 includes instructions 824. Instructions 824, when executed by processor(s) 814 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 800. Computing device 800 may be equipped with depth cameras, such as stereoscopic camera systems, infrared camera systems, RGB camera systems, and combinations of these, for gesture detection and recognition. Additionally, computing device 800 may be equipped with accelerometers or gyroscopes that enable detection of motion. The output of the accelerometers or gyroscopes may be provided to the display of computing device 800 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
generating a computing graph based on a neural network, the computing graph including a set of vertices representing operators and a set of directed edges representing a computing order and data dependency;
detecting a sub-graph within the computing graph matches at least one defined sub-structure;
combing a subset of vertices of the set of vertices corresponding to the sub-graph into a vertex by at least connecting a subset of directed edges of the set of directed edges to the vertex to generate an optimized graph, where the subset of directed edges correspond to inputs and outputs associated with the subset of vertices;
extracting a set of parameters from the optimized graph;
generating a net-list object and a weight object based on the optimized graph and the set of parameters; and
providing the net-list object and the weight object to an inference framework to enable the inference framework to perform inferencing.

2. The method of claim 1, wherein the sub-graph includes an isomorphic sub-graph.

3. The method of claim 2, wherein detecting the sub-graph within the computing graph further comprises using a graph isomorphism algorithm to determine the sub-graph is equivalent to the defined sub-structure.

4. The method of claim 1, wherein the method further comprises merging at least two parameters of the set of parameters.

5. The method of claim 4, wherein merging the at least two parameters further comprises merging a subset of parameters of the set of parameters into a weight value and a bias value, where the subset of parameters correspond to a batch normalization operation.

6. The method of claim 1, wherein the at least one defined sub-structure is stored in a macro library and indicates a set of operations of the neural network that can be performed by an operation of a kernel.

7. The method of claim 1, wherein the computing graphs further comprises a state space representation.

8. A non-transitory computer-readable medium storing executable instructions embodied thereon, which, when executed by a processing device, cause the processing device to perform operations comprising:
generating a computing graph including a set of vertices and a set of directed edges based on a machine learning model;
optimizing the computing graph to generate an optimized computing graph by at least combing a subset of vertices of the set of vertices corresponding to a sub-graph into a single vertex;
generating a net-list object and a weight object based on the optimized computing graph and a set of parameters extracted from the optimized computing graph; and
providing the net-list object and the weight object to a computing device.

9. The medium of claim 8, wherein the net-list indicates connectivity between layers of the machine learning model and a set of kernel operations associated with the layers, where the set of kernel operations are included in a software kernel of the computing device.

10. The medium of claim 9, wherein the single vertex corresponds to a kernel operation of the set of kernel operations.

11. The medium of claim 10, wherein the set of vertices represent operators and the set of directed edges represent a computing order corresponding to the operators and data dependency between vertices of the set of vertices.

12. The medium of claim 11, wherein the weight object indicates a set of weights assigned to the vertices of the set of vertices.

13. The medium of claim 8, wherein optimizing the computing graph to generate the optimized computing graph further comprises connecting a first subset of directed edges of the set of directed edges from a first subset of vertices of the set of vertices to the single vertex and connecting a second subset of directed edges of the set of directed edges from the single vertex to a second subset of vertices of the set of vertices, where the first subset of directed edges associated with the subset of vertices correspond to inputs and the second subset of directed edges correspond to outputs.

14. The medium of claim 8, wherein the machine learning model is a neural network.

15. The medium of claim 8, wherein providing the net-list object and the weight object to the computing device further comprises providing the net-list object and weight object to an inference framework executed by the computing device.

16. A system comprising:
a memory component; and
a processing device coupled to the memory component, the processing device to perform operations comprising:
detecting a set of sub-graphs of a computing graph, where sub-graphs of the set of sub-graphs match at least one sub-structure of a set of sub-structures defined for a computing device;
generating an optimized computing graph by at least combining a sub-graph of the set of sub-graphs into a single vertex of the optimized computing graph;
providing a net-list object and a weight object to the computing device, the net-list object and the weight object generated based on the optimized computing graph.

17. The system of claim 16, wherein sub-structures of the set of sub-structures define operations of a software kernel executed by the computing device.

18. The system of claim 16, wherein the computing graph includes a state space representation of a machine learning model.

19. The system of claim 18, wherein the machine learning model further comprises a neural network.

20. The system of claim 16, wherein combining the sub-graph of the set of sub-graphs into the single vertex comprises:
connecting a first set of directed edges of vertices of the computing graph to the single vertex, the first set of directed edges corresponding to inputs to the sub-graph;
connecting a second set of directed edges from the single vertex to vertices of the computing graph, the first set of directed edges corresponding to outputs to the sub-graph; and
removing a third set of directed edges corresponding to edges between vertices of the sub-graph.
